(19) United States
(12) Patent Application Publication
(10) Pub. No.: US 2020/0241183 A1
(43) Pub. Date: Jul. 30, 2020

(54) COLOR FILM STRUCTURE, COLOR FILM SUBSTRATE, DISPLAY PANEL AND DISPLAY DEVICE

(71) Applicant: BOE TECHNOLOGY GROUP CO., LTD., Beijing (CN)

(72) Inventors: Junbo Wei, Beijing (CN); Shengji Yang, Beijing (CN); Xiaochuan Chen, Beijing (CN)

(21) Appl. No.: 16/513,088

(22) Filed: Jul. 16, 2019

(30) Foreign Application Priority Data
Jan. 25, 2019 (CN) 201910071481.8

(51) Int. Cl. G02B 5/20

(52) U.S. Cl. CPC G02B 5/201

(57) ABSTRACT

The present disclosure provides a color film structure. The color film structure includes a first light transmission layer, a second light transmission layer, and a grating layer. The second light transmission layer is disposed at a side surface of the first light transmission layer, and the second light transmission layer has a refractive index is higher than that of the first light transmission layer. The grating layer is disposed at a side of the second light transmission layer away from the first light transmission layer, and includes one or more transmission gratings. Each of the transmission gratings is capable of transmitting light of one color.

### CROSS-REFERENCE TO RELATED APPLICATIONS

The present application is based on and claims the benefit of and priority to Chinese Patent Application No. 201910071481.8, filed on Jan. 25, 2019, the entire contents of which being incorporated herein by reference.

### TECHNICAL FIELD

The present disclosure relates to the field of display technologies, and in particular, to a color film structure, a color film substrate, a display panel, and a display device.

### BACKGROUND

The display device can realize color display by combining a white light emitting device and a color film structure. In the related art, the color film structure is generally fabricated from a plurality of pigments or dyes of different colors. However, pigments or dyes may fade and age over time, resulting in poor contrast ratio of the displayed image, and reducing service life and stability of the display device.

The above information disclosed in the Background section is only intended to enhance understanding of the background of the present disclosure, and thus may include information that does not constitute prior art known to those of ordinary skill in the art.

### SUMMARY

Arrangements of the present disclosure are to provide a color film structure, a color film substrate, a display panel, and a display device to improve service life and stability of the color film structure.

According to a first aspect of the present disclosure, a color film structure is provided. The color film structure includes a first light transmission layer, The color film structure includes a second light transmission layer disposed at a side surface of the first light transmission layer. The second light transmission layer has a refractive index higher than that of the first light transmission layer. The color film structure includes a grating layer disposed at a side of the second light transmission layer away from the first light transmission layer, and including one or more transmission gratings. Each of the one or more transmission gratings is capable of transmitting light of one color.

In an example arrangement of the present disclosure, a material of the first light transmission layer is a transparent plastic.

In an example arrangement of the present disclosure, the transparent plastic includes polymethyl methacrylate.

In an example arrangement of the present disclosure, a material of the second light transmission layer is an inorganic material.

In an example arrangement of the present disclosure, the inorganic material includes zinc sulfide.

In an example arrangement of the present disclosure, the transmission grating includes light shielding portions and light transmitting portions which are spaced apart, and a material of the light shielding portion includes metal.

In an example arrangement of the present disclosure, the grating layer includes a first transmission grating capable of transmitting red light, a second transmission grating capable of transmitting green light, and a third transmission grating capable of transmitting blue light.

In an example arrangement of the present disclosure, a grating period of the first transmission grating ranges from 420 to 450 nm. A grating period of the second transmission grating ranges from 340 to 360 nm. A grating period of the three transmission grating ranges from 260 to 280 nm.

In an example arrangement of the present disclosure, the first transmission grating includes a plurality of first light shielding strips arranged in a first direction. Each of the first light shielding strips has a width ranging from 315 to 338 nm. The second transmission grating includes a plurality of second light shielding strips arranged in a second direction. Each of the second light shielding strips has a width ranging from 255 to 270 nm. The third transmission grating includes a plurality of third light shielding strips arranged in a third direction. Each of the third shielding strips has a width ranging from 195 to 210 nm.

In an example arrangement of the present disclosure, the first transmission grating includes a plurality of first light shielding portions provided to be cylindrical and distributed in an array. Each of the first light shielding portions has a diameter ranging from 310 to 330 nm, and an axis perpendicular to the grating layer. The second transmission grating includes a plurality of second light shielding portions provided to be cylindrical and distributed in an array. Each of the second light shielding portions having a diameter ranging from 250 to 270 nm, and an axis perpendicular to the grating layer. The third transmission grating includes a plurality of third light shielding portions provided to be cylindrical and distributed in an array. Each of the third light shielding portions has a diameter ranging from 190 to 210 nm, and an axis perpendicular to the grating layer.

In an example arrangement of the present disclosure, the color film structure further includes a protective layer disposed at a side of the grating layer away from the first light transmission layer.

According to a second aspect of the present disclosure, a color film substrate is provided. The color film substrate includes a base substrate. The above-mentioned color film structure disposed at a side of the base substrate, and the first light transmission layer being disposed at a surface of the second light transmission layer away from the base substrate.

According to a third aspect of the present disclosure, a display panel is provided. The display panel includes a base substrate. The display panel includes a light emitting layer disposed at a side of the base substrate. The above-mentioned color film structure disposed at a side of the light emitting layer away from the substrate, the second light transmission layer being disposed at a surface of the first light transmission layer away from the base substrate.

According to a fourth aspect of the present disclosure, a display device is provided, including the above-mentioned display panel.

### BRIEF DESCRIPTION OF THE DRAWINGS

The above and other features and advantages of the present disclosure will become more apparent from the detailed description of the example embodiments with reference to the accompanying drawings.

FIG. 1 is a schematic structural view of a color film structure according to an implementation of the present disclosure.

FIG. 2 is a schematic structural top view of a transmission grating according to an implementation of the present disclosure.

FIG. 3 is a schematic structural top view of a transmission grating according to an implementation of the present disclosure.

FIG. 4 is a schematic structural top view of a grating layer according to an implementation of the present disclosure.

FIG. 5 is a schematic view showing a fabricating process of a color film structure according to an implementation of the present disclosure.

FIG. 6 is a schematic structural view of a color film substrate according to an implementation of the present disclosure.

FIG. 7 is a schematic structural view of a display panel according to an implementation of the present disclosure.

FIG. 8 is a schematic structural view of a silicon-based OLED display panel according to an implementation of the present disclosure.

### DETAILED DESCRIPTION

Example arrangements will now be described more fully with reference to the accompanying drawings. However, the example arrangements can be embodied in a variety of forms, and should not be construed as limitation of the examples set forth herein; rather, these arrangements are provided so that the present disclosure will be thorough and complete, and the concepts of the example arrangements will be fully given to those skilled in the art. The described features, structures, or characteristics may be combined in one or more arrangements in any suitable manner. In the following description, numerous specific details are provided in order to fully understand the arrangements of the present disclosure.

In the drawings, thicknesses of regions and layers may be exaggerated for clarity. The same reference numerals in the drawings denote the same or similar structures, and thus their detailed descriptions will be omitted.

The terms such as “a”, “an”, “the” and “said” are used to indicate the presence of one or more elements/components. The terms “comprise”, “include”, “have”, “contain” and their variants are used to be open-type and are meant to include additional elements/components, etc., in addition to the listed elements/components/etc. The terms “first”, “second”, etc. are used only as marks, rather than limitation for the number of objects.

OLED (Organic Light Emitting Diode) can actively emit light, and can provide light weight, wide field of view, high contrast ratio, fast response of display screen, low power consumption and realizability of full color display, so the OLED display device is widely used in the display field, especially in VR/AR (virtual reality/augmented reality) head-mounted display devices. So far, OLED display devices have been limited by the current process technology and cannot achieve true full color display.

In the related art, there are three main methods of colorization: a first method, a second method and a third method. In the first method, i.e., a RGB three-pixel independent light emitting method, three kinds of light emitting materials, i.e., red (R), green (G) and blue (B) light emitting materials, are used to independently emit light, and the full color is achieved by RGB three-color mixing. This method can provide high color saturation, high efficiency and high brightness; however, it may be subject to complicated manufacturing process, different RGB decay rates, and high energy consumption. In the second method, i.e., WOLED (white OLED)+color filter film method, RGB three primary color filter films are combined with WOLED. This method does not require a metal mask in the manufacturing process, without MASK aligning technology, so that this method is simple, the aperture ratio is not affected by RGB graphics, and the white light efficiency is high. The current manufacturing process of the color filter film is relatively mature, suitable for large-size screen display, and may also be used in small-sized screens. The color filter film has less expensive manufacturing cost, but its color and brightness is not as good as that in the first method. The third method, i.e., color conversion method, is to use blue electroluminescent material and photoluminescent color conversion material to obtain full color display without mask, which method requires high efficiency blue light. However, stability of blue light is poor, and there is a compatibility problem of discoloration medium materials and standard lithography tools.

The filter film is generally made of RGB three-color dyes or pigments. The method may be subject to dyes or pigments will fade and age over time, resulting in poor contrast ratio of the displayed image. The color filter made from traditional RGB three-color dyes or pigments typically has a service life of 20,000 to 30,000 hours.

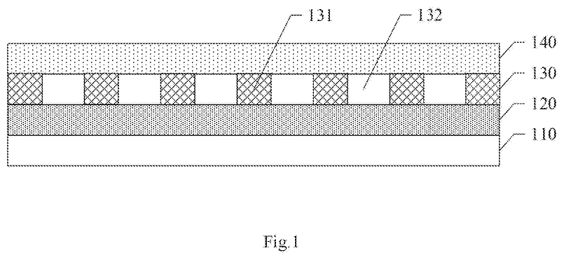

In the implementation of the present disclosure, a color film structure is provided. As shown in FIG. 1, the color film structure includes a first light transmission layer 110, a second light transmission layer 120, and a grating layer 130.

The second light transmission layer 120 is disposed at a side surface of the first light transmission layer 110, and the second light transmission layer 120 has a refractive index higher than that of the first light transmission layer 110; the grating layer 130 is disposed at a side of the second light transmission layer 120 away from the first light transmission layer 110, and includes at least one transmission grating; any of transmission gratings is capable of transmitting light of one color.

The present disclosure provides a color film structure having at least one transmission grating, and the transmission grating selectively enables light of a single color to be transmitted, thus having a function of transmission of colored light. The color film structure provided by the present disclosure is unnecessary to use pigments or dyes, avoiding the problem of aging and fading of pigments or dyes, and having characteristics of long service life and good stability. Moreover, the color film structure of the present disclosure further includes a first light transmission layer 110 and a second light transmission layer 120 at a side from which the light is incident, and there is a difference in refractive index between the second light transmission layer 120 and the first light transmission layer 110 such that the light incident from the first light transmission layer 110 will be refracted toward a side where a normal of the grating layer 130 is located, causing the light to converge toward the transmission grating, and increasing the intensity of the light transmitted by the transmission grating.

The various components of the color film structure provided by the implementations of the present disclosure are described in detail below with reference to the accompanying drawings:

A material of the first light transmission layer 110 is a transparent material having a lower refractive index, such as a transparent plastic. In one implementation, the material of the first light transmission layer 110 is polymethyl methacrylate (PMMA), or a mixture of PMMA and other transparent materials.

The second light transmission layer 120 is disposed at a side surface of the first light transmission layer 110, i.e., the first light transmission layer 110 has two opposite surfaces, one of which is connected to the second light transmission layer 120. A material of the second light transmission layer 120 is a transparent material having a higher refractive index, such as an inorganic transparent material. In one implementation, the material of the second light transmission layer 120 is zinc sulfide or a mixture of zinc sulfide and other inorganic materials.

In an implementation, materials and thicknesses of the first light transmission layer 110 and the second light transmission layer 120 may be reasonably controlled to increase the transmittance of light expected to be transmitted through the transmission grating, and to reduce the transmittance of light expected not to be transmitted through the transmission grating, improving the selective transmission capability of the color film structure to light of different colors, so that a wavelength range of the light transmitted by the color film structure is narrower, which is helpful to improve the color range and the contrast ratio of a display panel using the color film structure.

As shown in FIG. 1, the grating layer 130 includes at least one transmission grating; any of the transmission gratings includes light shielding portions 131 (opaque microstructures) and light transmitting portions 132 through which light is transmitted, which are spaced apart. A material of the light shielding portion 131 is an organic opaque material, an inorganic opaque material or a combination of a plurality of opaque materials.

In one implementation, the material of the light shielding portion 131 includes a metal to enhance the transmission capability of the target light by utilizing plasmon resonance of the metal surface such that the intensity of light of a single color (target light) transmitted through the transmission grating is greater. The metal material may be aluminum, silver, platinum or other metals. A thickness of the light shielding portion 131 ranges from 40 to 400 nm, in order to ensure effective transmission of light of the single color. It may be understood that the thickness of the light shielding portion 131 is a dimension of the light shielding portion 131 in the normal direction of the transmission grating.

The transmission grating may be formed by a photolithography process, a screen printing process, or other processes, which is not specifically limited in the present disclosure. The type of transmission grating may be determined according to the color that the color film structure is required to transmit. Correspondingly, each of the transmission gratings has a grating period corresponding to the target light (light that needs to be transmitted) to ensure that the target light can be transmitted, and that the color of the transmitted light is the target color.

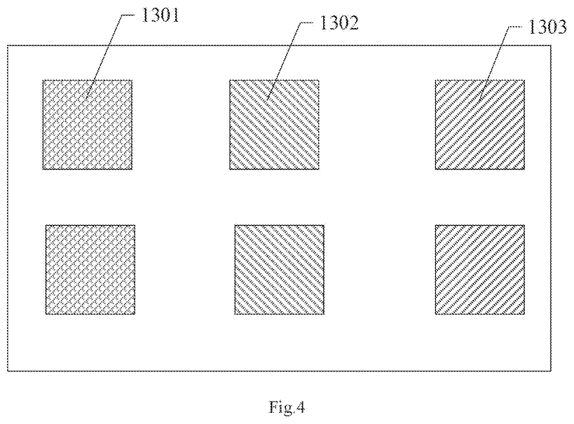

In an implementation, the color film structure requires to transmit light of three colors of R (red), G (green), and B (blue). As shown in FIG. 4, the grating layer 130 includes a first transmission grating 1301 capable of transmitting red light, a second transmission grating 1302 capable of transmitting green light, and a third transmission grating 1303 capable of transmitting blue light. In this way, the incident white light passes through the first light transmission layer 110 and the second light transmission layer 120 in sequence, and then passes through three different transmission gratings to realize the emission of the colored light, and thus to achieve the purpose of emitting red light, green light and blue light.

The grating period of the first transmission grating 1301 may be determined according to the wavelength range of red light required to be transmitted. In an implementation, the grating period of the first transmission grating 1301 ranges from 420 to 450 nm.

The grating period of the second transmission grating 1302 may be determined according to the wavelength range of green light required to be transmitted. In an implementation, the grating period of the second transmission grating 1302 ranges from 340 to 360 nm.

The grating period of the third transmission grating 1303 may be determined according to the wavelength range of blue light required to be transmitted. In an implementation, the grating period of the third transmission grating 1303 ranges from 260 to 280 nm.

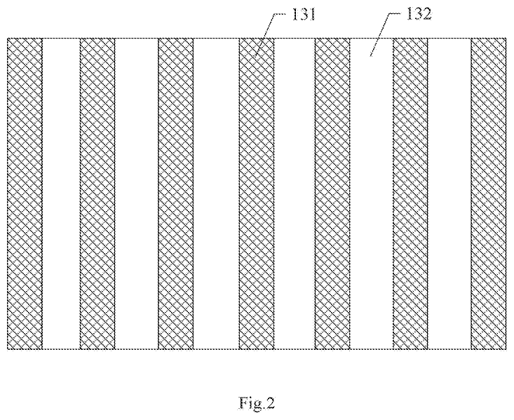

In one implementation, as shown in FIG. 2, the transmission grating is a stripe-shaped grating, and the light shielding portion 131 is a light shielding strip. A duty ratio of the transmission grating may be adjusted and determined as needed, for example, may be 0.75 or the like, which is not specifically limited in the present disclosure. It can be understood that the duty ratio of the transmission grating is a ratio of the width of the light shielding strip to the grating period in one grating period. The orthographic projection of light shielding strips of the transmission grating on the second light transmission layer 120 presents a plurality of strips arranged at intervals in the direction of a straight line, and the length direction of any of strips and light shielding strips is perpendicular to the straight line, and the width direction of any of strips and the light shielding strip is parallel to the straight line. The dimension of any strip in the width direction is the width of the light shielding strip corresponding to the strip.

For example, the first transmission grating 1301 includes a plurality of first light shielding strips arranged in a first direction, and any of the first light shielding strips has a width ranging from 315 to 338 nm. The first direction is perpendicular to the length direction of the first light shielding strip. The second transmission grating 1302 includes a plurality of second light shielding strips arranged in a second direction, and any of the second light shielding strips has a width ranging from 255 to 270 nm. The second direction is perpendicular to the length direction of the second light shielding strip. The third transmission grating 1303 includes a plurality of third light shielding strips arranged in a third direction, and any of the third light shielding strips has a width ranging from 195 to 210 nm. The third direction is perpendicular to the length direction of the third light shielding strip. It can be understood that the first direction, the second direction, and the third direction may be the same or partially the same, or may be different from each other.

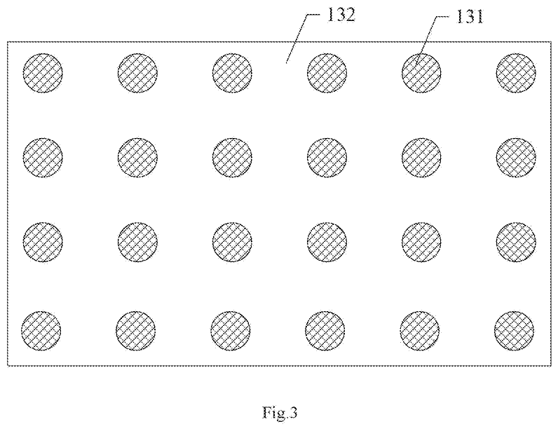

In another implementation, as shown in FIG. 3, the transmission grating is a two-dimensional grating including a plurality of cylindrical and array-distributed light shielding portions 131, and an axis of any of the light shielding portions 131 is perpendicular to the grating layer. The light shielding portions 131 may be distributed in an array based on a shape of triangle, square, hexagon or other regular shape. The diameter of any of circular light shielding portions 131 may be determined according to the color of light required to be transmitted through the transmission grating.

For example, the first transmission grating 1301 includes a plurality of cylindrical and array-distributed first light shielding portions. Any of the first light shielding portions has a diameter ranging from 310 to 330 nm, and an axis of any of the first light shielding portions is perpendicular to the grating layer. The second transmission grating 1302 includes a plurality of cylindrical and array-distributed second light shielding portions. Any of the second light shielding portions has a diameter ranging from 250 to 270 nm, and an axis of any of the second light shielding portions is perpendicular to the grating layer. The third transmission grating 1303 includes a plurality of cylindrical and array-distributed third light shielding portions. Any of the third light shielding portions has a diameter ranging from 190 to 210 nm, and an axis of any of the third light shielding portions is perpendicular to the grating layer.

In one implementation, as shown in FIG. 1, the color film structure further includes a protective layer 140 disposed at a side of the grating layer 130 away from the first light transmission layer 110 for preventing oxidation of the grating layer 130. The material of the protective layer 140 is an inorganic transparent material such as silicon oxide or silicon nitride.

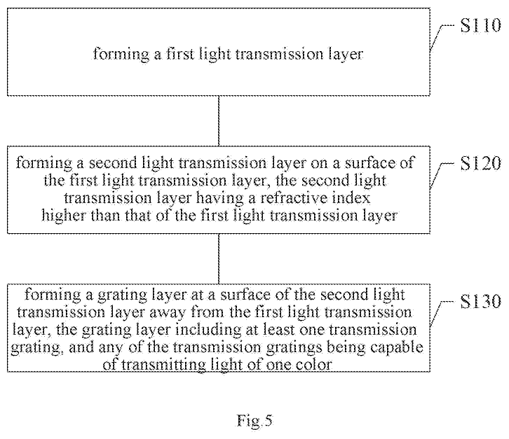

As shown in FIG. 5, the present disclosure also provides a fabricating method of a color film structure. The fabricating method includes:

Block S110: forming a first light transmission layer 110;

Block S120: forming a second light transmission layer 120 on a surface of the first light transmission layer 110, the second light transmission layer 120 having a refractive index higher than that of the first light transmission layer 110;

Block S130: forming a grating layer 130 at a surface of the second light transmission layer 120 away from the first light transmission layer 110, the grating layer 130 including at least one transmission grating, and any of the transmission gratings being capable of transmitting light of one color.

The color film structure fabricated by the fabricating method of the color film structure provided by the present disclosure and the color film structure described in the above implementation of the color film structure are the same, and thus have the same beneficial effects, which will not be described herein.

In the block S110, a base is provided in advance, and then a first light transmission layer 110 is formed on the substrate. The first light transmission layer 110 is formed by a process such as deposition, evaporation, printing, spin coating, etc., which is not specifically limited in the present disclosure. A material of the first light transmission layer 110 is a transparent material having a lower refractive index, such as a transparent plastic. In an implementation, the material of the first light transmission layer 110 is polymethyl methacrylate (PMMA).

In the block S120, the second light transmission layer 120 is formed by a process such as deposition, evaporation, printing, spin coating, etc., which is not specifically limited in the present disclosure. The material of the second light transmission layer 120 is a transparent material having a relatively high refractive index, such as an inorganic transparent material. In one implementation, the material of the second light transmission layer 120 is zinc sulfide or the like.

In block S130, the formed grating layer 130 includes at least one transmission grating. Any of the transmission gratings includes light shielding portions 131 (opaque microstructures) and light transmitting portions 132 which are spaced apart, and light is transmitted from the light transmitting portions 132. The material of the light shielding portion 131 is an organic opaque material, an inorganic opaque material or a combination of a plurality of opaque materials.

In one implementation, the material of the light shielding portion 131 includes a metal to enhance the transmission capability of the target light by utilizing the plasmon resonance of the metal surface such that the intensity of light of a single color (target light) transmitted through the transmission grating is greater. The metal material is aluminum, silver, platinum or other metals. A thickness of the light shielding portion 131 ranges from 40 to 400 nm, in order to ensure effective transmission of light of the single color. It can be understood that the thickness of the light shielding portion 131 is a dimension of the light shielding portion 131 in the normal direction of the transmission grating.

The transmission grating may be formed by a photolithography process, a screen printing process, or other processes, which is not specifically limited in the present disclosure.

For example, in an implementation, the transmission grating may be formed by a photolithography process, and the method may include:

Block S210: forming an aluminum film layer at a surface of the second light transmission layer 120 away from the first light transmission layer 110;

Block S220: forming a photoresist layer at a surface of the aluminum film layer away from the second light transmission layer 120;

Block S230: transferring a pattern of the transmission grating to the photoresist layer by exposure technique by means of a mask;

Block S240: developing to expose a part of the aluminum film layer;

Block S250: etching to remove the exposed aluminum film layer;

Block S260: removing the photoresist layer to obtain a transmission grating.

In one implementation, as shown in FIG. 4, the grating layer 130 includes a first transmission grating 1301 capable of transmitting red light, a second transmission grating 1302 capable of transmitting green light, and a third transmission grating 1303 capable of transmitting blue light.

The grating period of the first transmission grating 1301 may be determined according to the wavelength range of red light required to be transmitted. In an implementation, the grating period of the first transmission grating 1301 ranges from 420 to 450 nm.

The grating period of the second transmission grating 1302 may be determined according to the wavelength range of the green light required to be transmitted. In an implementation, the grating period of the second transmission grating 1302 ranges from 340 to 360 nm.

The grating period of the third transmission grating 1303 may be determined according to the wavelength range of the blue light required to be transmitted. In an implementation, the grating period of the third transmission grating 1303 ranges from 260 to 280 nm.

In one implementation, the first transmission grating 1301 includes a plurality of first light shielding strips arranged in a first direction, and any of the first light shielding strips has a width ranging from 315 to 338 nm. The first direction is perpendicular to the length direction of the first light shielding strip. The second transmission grating 1302 includes a plurality of second light shielding strips arranged in the second direction, and any of the second light shielding strips has a width ranging from 255 to 270 nm. The second direction is perpendicular to the length direction of the second light shielding strip. The third transmission grating 1303 includes a plurality of third light shielding strips arranged in the third direction, and any of the third light shielding strips has a width ranging from 195 to 210 nm. The third direction is perpendicular to the length direction of the third light shielding strip. It can be understood that the first direction, the second direction, and the third direction may be the same or partially the same, or may be different from each other.

In one implementation, the first transmission grating 1301 includes a plurality of cylindrical and array-distributed first and second light shielding portions. Any of the first light shielding portions has a diameter ranging from 310 to 330 nm, and an axis of any of the first light shielding portions is perpendicular to the grating layer. The second transmission grating 1302 includes a plurality of cylindrical and array-distributed second light shielding portions. Any of the second light shielding portions has a diameter ranging from 250 to 270 nm, and an axis of any of the second light shielding portions is perpendicular to the grating layer. The third transmission grating 1303 includes a plurality of cylindrical and array-distributed third light shielding portions. Any of the third light shielding portions has a diameter ranging from 190 to 210 nm, and an axis of any of the third light shielding portions is perpendicular to the grating layer.

In an implementation, the fabricating method of the color film structure further includes:

Block S140: forming a protective layer 140 on a surface of the grating layer 130 away from the first light transmission layer 110, in which a material of the protective layer 140 is an inorganic transparent material, such as silicon oxide or silicon nitride, which may be used to prevent oxidation of the grating layer 130.

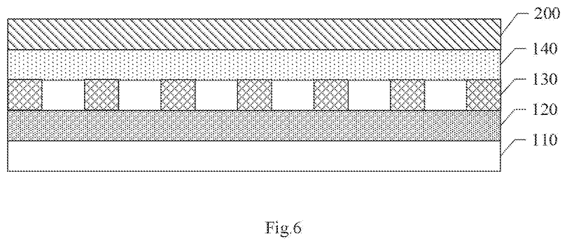

The present disclosure further provides a color film substrate. As shown in FIG. 6, the color film substrate includes a base substrate 200 and a color film structure disposed at a side of the base substrate 200. The color film structure is the color film structure described in the above color filter structure implementation, and the grating layer 130 is disposed at a side of the base substrate 200, the second light transmission layer 120 is disposed at a surface of the grating layer 130 away from the base substrate 200, and the first light transmission layer 110 is disposed at a surface of the light transmission layer 120 away from the base substrate 200. In this way, the color film substrate may be cooperated with the array substrate to form a liquid crystal display panel.

The color film structure of the color film substrate provided by the present disclosure is the same as the color film structure described in the above implementation of the color film structure, and thus has the same beneficial effects. Therefore, the present disclosure will not be repeated herein.

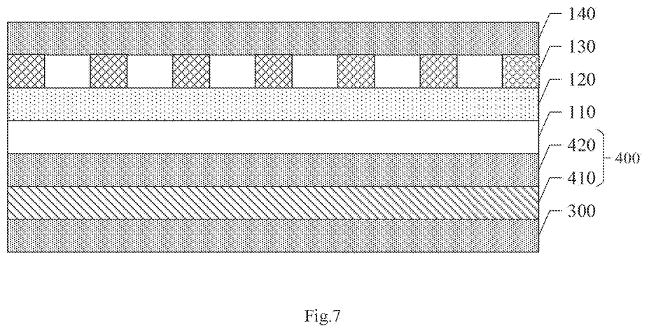

The present disclosure further provides a display panel. As shown in FIG. 7, the display panel includes a base substrate 300, a light emitting layer 400, and a color film structure. The light emitting layer 400 is disposed at a side of the base substrate 300. The color film structure is any one of color film structures described in the above implementations. The color film structure is disposed at a side of the light emitting layer 400 away from the base substrate 300, and the first light transmission layer 110 is disposed at a side of the light emitting layer 400 away from the base substrate 300, the second light transmission layer 120 is disposed at a surface of the first light transmission layer 110 away from the base substrate 300, and the grating layer 130 is disposed at a surface of the second light transmission layer 120 away from the base substrate 300.

The color film structure of the display panel provided by the present disclosure is the same as the color film structure described in the above color film structure implementation, and therefore has the same beneficial effects. Therefore, the present disclosure will not be repeated herein.

In one implementation, as shown in FIG. 7, the light emitting layer 400 includes a light emitting component layer 410 and a transparent electrode 420. The light emitting component layer 410 is disposed at a side of the base substrate 300. The transparent electrode 420 is disposed at a surface of the light emitting component layer 410 away from the base substrate 300, and is disposed at a surface of the first light transmission layer 110 close to the base substrate 300. In this way, the color film structure is disposed at the surface of the transparent electrode 420, which reduces a distance between the color film structure and the light emitting component layer, facilitates the improvement of the light emitting angle of the display panel, and improves the field of view and light emitting efficiency of the display panel.

In one implementation, the display panel is a liquid crystal display panel. The light emitting layer 400 includes a driving circuit layer disposed at a side of the base substrate 300, a pixel electrode layer disposed at a side of the driving circuit layer away from the base substrate 300, a liquid crystal layer disposed at a side of the pixel electrode layer away from the base substrate 300, and a common electrode layer at a side of the liquid crystal layer away from the base substrate 300.

In another implementation, the display panel is an OLED display panel, which includes, but is not limited to, an organic TFT (Thin Film Transistor) OLED, LTPS (Low Temperature Polysilicon)-TFT OLED, HTPS (High Temperature Polysilicon)-TFT OLED, LTPO (Low Temperature Polysilicon/Metal Oxide)-TFT OLED and silicon based OLED.

Hereinafter, an implementation of the display panel provided by the present disclosure is introduced and illustrated by taking a silicon-based OLED display panel as an example.

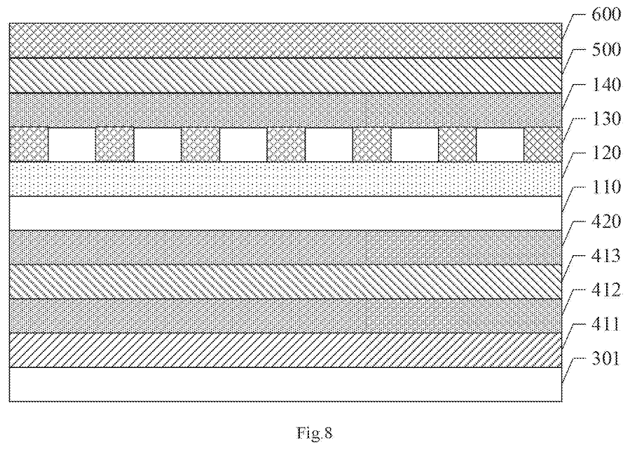

As shown in FIG. 8, the silicon-based OLED display panel includes: a silicon-based base substrate 301; a pixel driving circuit layer 411 disposed at the silicon-based base substrate 301; an anode layer 412 disposed at a side of the pixel driving circuit layer 411 away from the silicon-based base substrate 301; an organic light emitting layer 413 disposed at a surface of the anode layer 412 away from the silicon-based base substrate 301; a transparent electrode 420 disposed at a surface of the organic light emitting layer 413 away from the silicon-based base substrate 301; a color film structure disposed at a surface of a cathode layer away from the silicon-based base substrate 301. A first light transmission layer 110 is disposed at the surface of the cathode layer away from the silicon-based base substrate 301, and a second light transmission layer 120 is disposed at a surface of the first light transmission layer 110 away from the silicon-based base substrate 301, and a grating layer 130 is disposed at a surface of the second light transmission layer 120 away from the silicon-based base substrate 301. The silicon-based OLED display panel includes a thin film package layer 500 disposed at a side of the color film structure away from the silicon-based base substrate 301, and a glass cover plate 600 disposed at a side of the thin film package layer 500 away from the silicon-based base substrate 301.

In one implementation, the pixel driving circuit layer 411 includes a pixel driving circuit that is etched onto the silicon-based base substrate 301 or into the silicon-based base substrate 301 by a CMOS (Complementary Metal Oxide Semiconductor) process. The CMOS process is mature, and facilitates the fabricating of silicon-based OLED display panel.

In one implementation, a material of the anode layer 412 is a transparent conductive material such as ITO (indium tin oxide) or TiN (titanium nitride). The organic light emitting layer 413 includes an organic electroluminescence material that emits light under the action of a voltage or a current. The cathode layer is a transparent conductive layer such as an aluminum-magnesium alloy layer or a silver electrode layer.

In one implementation, the thin film package layer 500 is a thin film layer structure in which an organic material is combined with an inorganic material. The inorganic material is one or more of silicon nitride and aluminum oxide, so that the package characteristics have been enhanced, and the invasion of water and oxygen is effectively prevented. The glass cover plate 600 adopts a GNA glass with a better transmission of light.

The present disclosure also provides a display device including any of display panels described in the above display panel implementation, and thus can provide similar improvements as those of the display panel described in the above display panel implementation, which will not be repeated again. The display device may be a mobile phone screen, a notebook screen, a television screen, a watch screen or other device having a display function.

According to the color film structure and the fabricating method thereof, the color film substrate, the display panel and the display device provided by the present disclosure, the color film structure has at least one transmission grating and the transmission grating may selectively transmit light of a single color, having a function of transmission of a colored light. The color film structure provided by the present disclosure is unnecessary to use pigments or dyes, avoiding the problem of aging and fading of pigments or dyes, and having characteristics of long service life and good stability. Moreover, the color film structure of the present disclosure further includes a first light transmission layer and a second light transmission layer at a side from which the light is incident, and there is a difference in refractive index between the second light transmission layer and the first light transmission layer such that the light incident from the first light transmission layer will be refracted toward a side where a normal of the grating layer is located, causing the light to converge toward the transmission grating, and increasing the intensity of the light transmitted by the transmission grating.

It should be understood that the present disclosure does not limit its application to the detailed structure and arrangement of the components presented in the specification. The present disclosure is capable of having other implementations and can be achieved and performed in various ways. The foregoing variations and modifications are intended to fall within the scope of the present disclosure. It should be understood that the present disclosure disclosed and defined herein extends to all alternative combinations of two or more individual features that are mentioned or apparent in the drawings. All of these different combinations constitute a number of alternative aspects of the present disclosure. The implementations described in the specification are illustrative of the best mode intended to implement the present disclosure, and will enable those skilled in the art to utilize the present disclosure.

What is claimed is:

1. A color film structure, comprising:
a first light transmission layer;
a second light transmission layer disposed at a side surface of the first light transmission layer, the second light transmission layer having a refractive index higher than that of the first light transmission layer;
a grating layer disposed at a side of the second light transmission layer away from the first light transmission layer, and including one or more transmission gratings, each of the one or more of transmission gratings being capable of transmitting light of one color.

2. The color film structure according to claim 1, wherein a material of the first light transmission layer is a transparent plastic.

3. The color film structure according to claim 2, wherein the transparent plastic comprises polymethyl methacrylate.

4. The color film structure according to claim 1, wherein a material of the second light transmission layer is an inorganic material.

5. The color film structure according to claim 4, wherein the inorganic material comprises zinc sulfide.

6. The color film structure according to claim 1, wherein each of the one or more transmission gratings comprises light shielding portions and light transmitting portions which are spaced apart, and a material of the light shielding portion comprises metal.

7. The color film structure according to claim 1, wherein the grating layer comprises:
a first transmission grating capable of transmitting red light;
a second transmission grating capable of transmitting green light;
a third transmission grating capable of transmitting blue light.

8. The color filter structure according to claim 7, wherein a grating period of the first transmission grating ranges from 420 to 450 nm; a grating period of the second transmission grating ranges from 340 to 360 nm; and a grating period of the three transmission grating ranges from 260 to 280 nm.

9. The color film structure according to claim 8, wherein the first transmission grating comprises a plurality of first light shielding strips arranged in a first direction, each of the plurality of first light shielding strips having a width ranging from 315 to 338 nm; wherein the second transmission grating comprises a plurality of second light shielding strips arranged in a second direction, each of the plurality of second light shielding strips having a width ranging from 255 to 270 nm; and wherein the third transmission grating comprises a plurality of third light shielding strips arranged in a third direction, each of the plurality of third shielding strips having a width ranging from 195 to 210 nm.

10. The color film structure according to claim 8, wherein the first transmission grating comprises a plurality of first light shielding portions provided to be cylindrical and distributed in an array, each of the plurality of first light shielding portions having a diameter ranging from 310 to 330 nm, and having an axis perpendicular to the grating layer; the second transmission grating comprises a plurality of second light shielding portions provided to be cylindrical and distributed in an array, each of the plurality of second light shielding portions having a diameter ranging from 250 to 270 nm, and having an axis perpendicular to the grating layer; the third transmission grating comprises a plurality of third light shielding portions provided to be cylindrical and distributed in an array, each of the plurality of third light shielding portions having a diameter ranging from 190 to 210 nm, and having an axis perpendicular to the grating layer.

11. The color film structure according to claim 1, wherein the color film structure further comprises:
a protective layer disposed at a side of the grating layer away from the first light transmission layer.

12. A color film substrate, comprising:
a base substrate;
the color film structure according to claim 1, the color film structure being disposed at a side of the base substrate, and the first light transmission layer being disposed at a surface of the second light transmission layer away from the base substrate.

13. A display panel, comprising:
a base substrate;
a light emitting layer disposed at a side of the base substrate;
the color film structure according to claim 1, the color film structure being disposed at a side of the light emitting layer away from the base substrate, and the second light transmission layer being disposed at a surface of the first light transmission layer away from the base substrate.

14. A display device comprising the display panel according to claim 13.
